(19) United States
(12) Patent Application Publication
(10) Pub. No.: US 2025/0190826 A1
(43) Pub. Date: Jun. 12, 2025

(54) Method for Constructing Boolean Algebra System of Ising Perceptual Computer and Ising Machine Programming Interface

(71) Applicant: SHANGHAITECH UNIVERSITY, Shanghai (CN)

(72) Inventors: Jianwen LUO, Shanghai (CN); Yajun HA, Shanghai (CN)

(73) Assignee: SHANGHAITECH UNIVERSITY, Shanghai (CN)

(21) Appl. No.: 18/898,799

(22) Filed: Sep. 27, 2024

Related U.S. Application Data
(63) Continuation of application No. PCT/CN2024/085251, filed on Apr. 1, 2024.

(30) Foreign Application Priority Data
Dec. 6, 2023 (CN) 202311669059.5

(51) Int. Cl. G06N 7/01; G06N 10/40

(52) U.S. Cl. CPC G06N 7/01; G06N 10/40; G06N 10/80

(57) ABSTRACT

A method for constructing a Boolean algebra system of an Ising perceptual computer and an Ising machine programming interface involve a quantum circuit synthesis system of Boolean algebra of the Ising perceptual computer for solving a constrained optimization problem, and a programming interface for a quantum Ising machine implementing quantum adiabatic computation and other general-purpose Ising machines, and relate to the field of constrained optimization and quantum adiabatic computation. A Boolean constraint primitive expression system described by a penalty term is used as a basic expression object, and automatic, efficient, and reliable rearrangement and simplification are carried out through an algebra system of the Ising perceptual computer. Combining a characteristic of an Ising machine, a scale of an optimization problem instance is reduced and solving efficiency of the optimization problem instance on the Ising machine is improved.

### CROSS REFERENCE TO THE RELATED APPLICATIONS

This application is the continuation application of International Application No. PCT/CN2024/085251, filed on Apr. 1, 2024, which is based upon and claims priority to Chinese Patent Application No. 202311669059.5, filed on Dec. 6, 2023, the entire contents of which are incorporated herein by reference.

### TECHNICAL FIELD

The present disclosure relates to the technical field of constrained optimization and quantum adiabatic computation, and specifically, to a method for constructing a Boolean algebra system of an Ising perceptual computer and an Ising machine programming interface.

### BACKGROUND

The construction of a penalty term for an arithmetic constraint on an integer variable is a necessary step in solving a constrained optimization problem using an Ising machine. The Ising machine can only solve an unconstrained problem directly, and a practical NP-hard problem often involves a plurality of arithmetic constraints represented by a linear constraint. Therefore, it is necessary to construct a quadratic unconstrained binary optimization (QUBO) form from a to-be-solved problem by constructing the penalty term for the arithmetic constraint on the integer variable, such that the Ising machine can solve the to-be-solved problem. Considering that the Ising machine led by a quantum annealer has an extremely limited quantity of bits and a restricted interaction accuracy and topology, a method for constructing the penalty term for the arithmetic constraint on the integer variable greatly affects the scale and quality of a single-machine solvable solution of the problem.

However, in existing penalty term construction algorithms for the arithmetic constraint, there is a linear relationship between a quantity of bits and a width of a dynamic range and a quantity of interactions is proportional to a square of the width of the dynamic range, or a dynamic range of interaction strength cannot consider both the practicality of the problem and accuracy of the Ising machine. As a result, complexity of constructing the QUBO form from the to-be-solved problem increases rapidly, limiting the scale of a solvable problem on the Ising machine represented by the quantum annealer.

In order to resolve this problem, relevant experts have made explorations in different aspects. In the series of work in [1], a QUBO form of a simple Boolean logic gate is provided, which is only limited to a Boolean logic problem, and no construction of arithmetic logic is provided. In the series of construction in [2], efficient encoding of the integer variable in the case of the limited dynamic range and accuracy of the interaction is provided, but a bijective relationship between encoding and a variable value is broken. In addition, construction of the arithmetic constraint under the new encoding is still significantly limited by the dynamic range and accuracy of the interaction. In [3], QUBO forms of a plurality of NP-hard problems are provided, but the discussed problems do not involve the arithmetic constraint, and naïve reduction of the practical NP-hard problem to a related problem is still subject to the basic limitations mentioned above. In [4], squaring is avoided in the construction, such that an impact of the dynamic range of the interaction on accuracy of arithmetic encoding has been reduced, but this impact has not been completely eliminated. In addition, a negative impact that introducing continuous variables is limited by the accuracy of the interaction has been ignored, and a requirement for iterative assisted solving on a traditional computer has been introduced, which reduces efficiency of problem solving. In [5], various construction methods including [1-4] have been summarized, but they are still subject to the basic limitations mentioned above.

In constrained optimizer software, advanced annealing computers led by a quantum Ising machine significantly improve the operating speed and result quality of the tool for a small-scale problem instance. However, the above problems hinder the application of the constrained optimizer software on the quantum Ising machines to a problem instance.
[1] J. Su, T. T u and L. He, “A quantum annealing approach for Boolean Satisfiability problem,” 2016 53nd ACM/EDAC/IEEE Design Automation Conference (DAC), Austin, TX, USA, 2016, pp. 1-6, doi: 10.1145/2897937.2897973.
[2] Karimi, S., Ronagh, P. Practical integer-to-binary mapping for quantum annealers. Quantum Inf Process 18, 94 (2019). https://doi.org/10.1007/s11128-019-2213-x
[3] Lodewijks, Bas. “Mapping NP-Hard and NP-Complete Optimisation Problems to Quadratic Unconstrained Binary Optimisation Problems.” arXiv.org, 3 Aug. 2020, arxiv.org/abs/1911.08043.
[4] Djidjev, Hristo N. “Quantum Annealing with Inequality Constraints: The Set Cover Problem.” arXiv.org, 22 Feb. 2023, arxiv.org/abs/2302.11185.
[5] Reformulating a Problem.” D-Wave, docs.dwavesys.com/docs/latest/handbook_reformulating.html. Accessed 30 Nov. 2023.

### SUMMARY

An objective of the present disclosure is to provide a method for constructing a Boolean algebra system of an Ising perceptual computer for solving a constrained optimization problem, and to provide a programming interface for a quantum Ising machine implementing quantum adiabatic computation and other general-purpose Ising machines.

A technical solution of the present disclosure provides a method for constructing a Boolean algebra system of an Ising perceptual computer, including the following steps:
step S1: constructing a domain-specific constrained optimization primitive expression system in a high-level programming language, and providing a parameterized abstract constrained optimization primitive for four domains of electronic design automation, finance, energy, and communication;
step S2: constructing a domain-independent constrained optimization primitive expression system in the high-level programming language, and providing parameterized abstract constrained optimization primitives including variable management, an equality constraint, a non-equality constraint, an inequality constraint, a one-hot constraint, a selection constraint, an extremum constraint, a summation constraint, and a linear constraint;
step S3: in the high-level programming language, for the four domains of electronic design automation, finance, energy, and communication, combined with domain-specific knowledge, constructing a domain knowledge decomposition from a constrained optimization complex expressed by the domain-specific constrained optimization primitive expression system to a constrained optimization complex expressed by the domain-independent constrained optimization primitive expression system, and expanding each domain-specific parameterized abstract constrained optimization primitive in the S1 into a set of each domain-independent parameterized abstract constrained optimization primitive in the S2;
step S4: constructing a Boolean constraint primitive expression system described by a penalty term quantum circuit in the high-level programming language, and providing a NOT-gate constraint, an AND-gate constraint, an OR-gate constraint, a constraint on derivation of a gate from single-input inversion, an XOR-gate constraint, and an XNOR-gate constraint;
step S5: in the high-level programming language, constructing a Boolean expansion from the constrained optimization complex expressed by the domain-independent constrained optimization primitive expression system to a constrained optimization complex expressed by the Boolean constraint primitive expression system described by the penalty term quantum circuit, and unstructurally expanding each domain-independent constrained optimization primitive in the S2 into an unstructured set of a Boolean constraint primitive described by each penalty term quantum circuit in the S4; and
step S6: constructing a quantum circuit synthesis based on Ising perception and computer Boolean algebra in the high-level programming language, and providing functions including constant propagation, constant folding, NOT-gate fusion, chain-shaped reduction, tree-shaped reduction, computational strength reduction, sparse format export, and dense format export.

Preferably, the constraint on derivation of the gate from single-input inversion is obtained by expanding and simplifying a penalty term of a corresponding non-inverting gate through inverting variable substitution x→(1−x).

Preferably, in the step S5, based on a domain, the equality constraint is expanded into an equivalent quantum circuit for summating an XNOR-gate penalty term, the non-equality constraint is expanded into an equivalent quantum circuit for performing an AND operation on all bitwise XOR operation results, the inequality constraint is expanded bit by bit to make a high bit satisfy an inequality or make the high bit satisfy an equation and a low bit satisfy an inequality, the one-hot constraint is expressed as an equivalent quantum circuit for performing an OR operation on all AND operation results of adjacent bits, the selection constraint is expanded into the one-hot constraint and a bitwise selection, the extremum constraint is expanded into the corresponding inequality constraint and selection constraint before being further expanded, and the summation constraint is expanded based on at least one expansion selected based on a bit length of an augend.

Preferably, the bitwise selection is expanded into an equivalent quantum circuit for performing an OR operation on all AND operation results of a to-be-selected variable and a one-hot variable.

Preferably, in the step 6, the constant propagation is performed during initialization, the NOT-gate fusion, the chain-shaped reduction, the tree shaped reduction, the computational strength reduction, the sparse format export, and the dense format export to eliminate a bit with a known value as a constant and replace the bit with a constant until there is no bit with a known value as a constant; and the constant folding is performed after the constant propagation to simplify a constraint containing a constant until a remaining constraint does not contain a constant.

Preferably, in the step 6, the NOT-gate fusion is performed when there is a NOT gate or an XNOR gate in a quantum circuit, to utilize an Ising characteristic to further eliminate qubit usage and qubit interactions, thereby reducing a dynamic range of the interaction.

Preferably, in the step 6, when there is a NOT gate, the NOT gate is eliminated, and a gate that uses a result of the NOT gate is converted by using an original bit based on (AND <->single-input invereted AND <->NOR), (OR<->single input-inverted OR<->NAND), and (XOR <->XNOR); and when there is an XNOR gate, the XNOR gate is replaced by an XOR gate, and a gate that uses a result of the XNOR gate is converted based on (AND <->single-input invereted AND <->NOR), (OR<->single input-inverted OR<->NAND), and (XOR <->XNOR).

Preferably, in the step 6, the chain-shaped reduction converts an unstructured gate set into a chain topology quantum circuit through bitwise recurrence from high bit to low bit; the tree-shaped reduction converts the unstructured gate set into a tree topology quantum circuit through pairing and recursive binary merging greedy; the computational strength reduction decomposes multiplication with an integer constant into a shift-addition quantum circuit; the sparse format export exports, in a format of a coordinate index sparse matrix, the chain topology quantum circuit, the tree topology quantum circuit, and the shift-addition quantum circuit that are respectively obtained through the chain-shaped reduction, the tree-shaped reduction, and the computational strength reduction; and the dense format export exports, in a format of an upper triangular matrix, the chain topology quantum circuit, the tree topology quantum circuit, and the shift-addition quantum circuit that are respectively obtained through the chain-shaped reduction, the tree-shaped reduction, and the computational strength reduction; where the sparse format export and the dense format export sort a bit variable, record a self-interaction into a diagonal term, and merge an interaction of a bit variable pair into a corresponding subscript position.

Another technical solution of the present disclosure provides an Ising machine programming interface, adopting the method for constructing a Boolean algebra system of an Ising perceptual computer, and including:
an annealer-specific neutral input interface disposed in the high-level programming language and configured to provide a specific implementation for a real machine of a mainstream supplier to submit a quantum circuit to the real machine;
an annealer-specific neutral output interface disposed in the high-level programming language and configured to provide a specific implementation for the real machine of the mainstream supplier to obtain an operation process statistic and an operation result of the quantum circuit from the real machine; and
a numerical output and visualization system disposed in the high-level programming language and configured to provide a function of outputting and storing a numerical result and a function of visualizing an operation optimization process and result of the quantum circuit.

Preferably, the function of outputting and storing the numerical result converts a result read back from the annealer-specific neutral output interface into a numerical matrix and stores the numerical matrix in a memory and/or a hard disk; and the visualization function includes a column diagram of quantities of hits on different optimization target values and an evolution trajectory of a systematic Hamiltonian over time.

The present disclosure provides a method for constructing a Boolean algebra system of an Ising perceptual computer and an Ising machine programming interface, involves a quantum circuit synthesis system of Boolean algebra of the Ising perceptual computer for solving a constrained optimization problem, and a programming interface for a quantum Ising machine implementing quantum adiabatic computation and other general-purpose Ising machines, and relates to the field of constrained optimization and quantum adiabatic computation. A Boolean constraint primitive expression system described by a penalty term is used as a basic expression object, and automatic, efficient, and reliable rearrangement and simplification are carried out through an algebra system of the Ising perceptual computer. Combining a characteristic of an Ising machine, a scale of an optimization problem instance is reduced and solving efficiency of the optimization problem instance on the Ising machine is improved.

### BRIEF DESCRIPTION OF THE DRAWINGS

FIG. 1 is a structural diagram of a Boolean algebra system of an Ising perceptual computer according to an embodiment of the present disclosure;

FIG. 2 shows a formula for an equality constraint according to an embodiment of the present disclosure;

FIGS. 3A-3B show a formula for a non-equality constraint according to an embodiment of the present disclosure;

FIGS. 4A-4B show a formula for an inequality constraint according to an embodiment of the present disclosure;

FIGS. 5A-5B show a formula for a one-hot constraint according to an embodiment of the present disclosure; and

FIG. 6 shows a formula for a selection constraint according to an embodiment of the present disclosure.

### DETAILED DESCRIPTION OF THE EMBODIMENTS

The present disclosure will be described in detail below in connection with specific embodiments. It should be understood that these embodiments are only intended to describe the present disclosure, rather than to limit the scope of the present disclosure. In addition, it should be understood that various changes and modifications may be made on the present disclosure by those skilled in the art after reading the content of the present disclosure, and these equivalent forms also fall within the scope defined by the appended claims of the present disclosure.

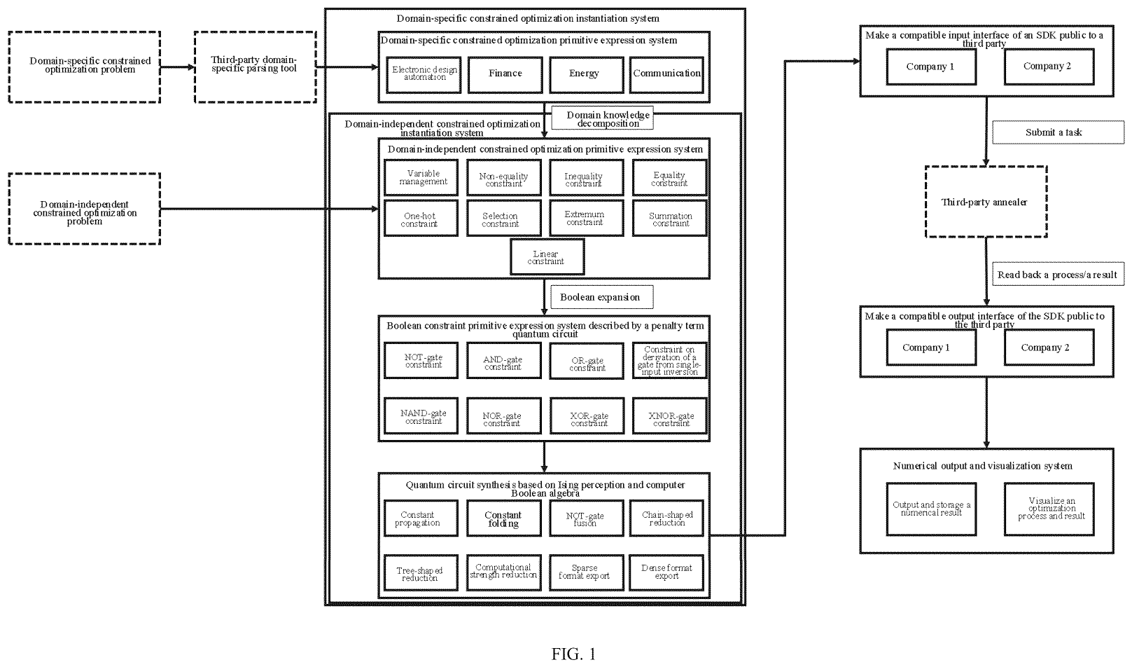

In the embodiments, as shown in FIG. 1, a Boolean algebra system of an Ising perceptual computer for solving a constrained optimization problem is provided. A method for constructing the Boolean algebra system of the Ising perceptual computer includes the following steps:
Step S1: A domain-specific constrained optimization primitive expression system is constructed in a high-level programming language, and a parameterized abstract constrained optimization primitive is provided for four domains of electronic design automation, finance, energy, and communication.
Step S2: A domain-independent constrained optimization primitive expression system is constructed in the high-level programming language, and parameterized abstract constrained optimization primitives are provided, including variable management, an equality constraint, a non-equality constraint, an inequality constraint (greater than, greater than or equal to, less than, and less than or equal to), a one-hot constraint, a selection constraint, an extremum constraint (a maximum and a minimum), a summation constraint, and a linear constraint.
Step S3: In the high-level programming language, for the four domains of electronic design automation, finance, energy, and communication, combined with domain-specific knowledge, a domain knowledge decomposition from a constrained optimization complex expressed by the domain-specific constrained optimization primitive expression system to a constrained optimization complex expressed by the domain-independent constrained optimization primitive expression system is constructed, and each domain-specific parameterized abstract constrained optimization primitive in the S1 is expanded into a set of each domain-independent parameterized abstract constrained optimization primitive in the S2.
Step S4: A Boolean constraint primitive expression system described by a penalty term quantum circuit is constructed in the high-level programming language, and a NOT-gate constraint, an AND-gate constraint, an OR-gate constraint, a constraint on derivation of a gate from single-input inversion (a single-input inverting AND gate and a single-input inverting OR gate), an XOR-gate constraint, and an XNOR-gate constraint are provided.

The constraint on derivation of the gate from single-input inversion is obtained by expanding and simplifying a penalty term of a corresponding non-inverting gate through inverting variable substitution x→(1−x).
Step S5: In the high-level programming language, a Boolean expansion from the constrained optimization complex expressed by the domain-independent constrained optimization primitive expression system to a constrained optimization complex expressed by the Boolean constraint primitive expression system described by the penalty term quantum circuit is constructed, and each domain-independent constrained optimization primitive in the S2 is unstructurally expanded into an unstructured set of a Boolean constraint primitives described by each penalty term quantum circuit in the S4.

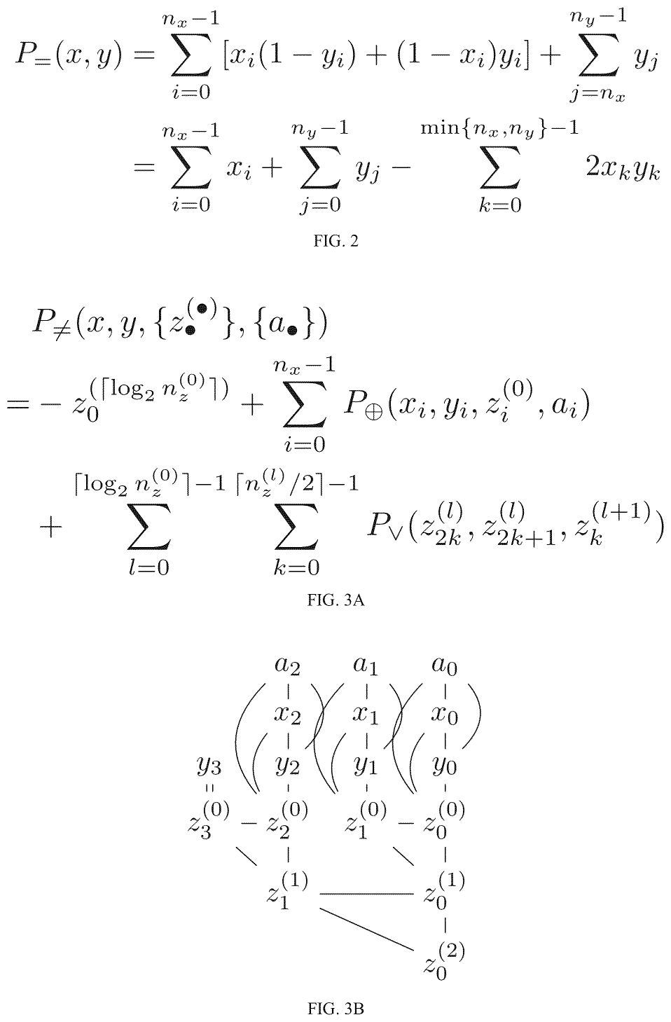

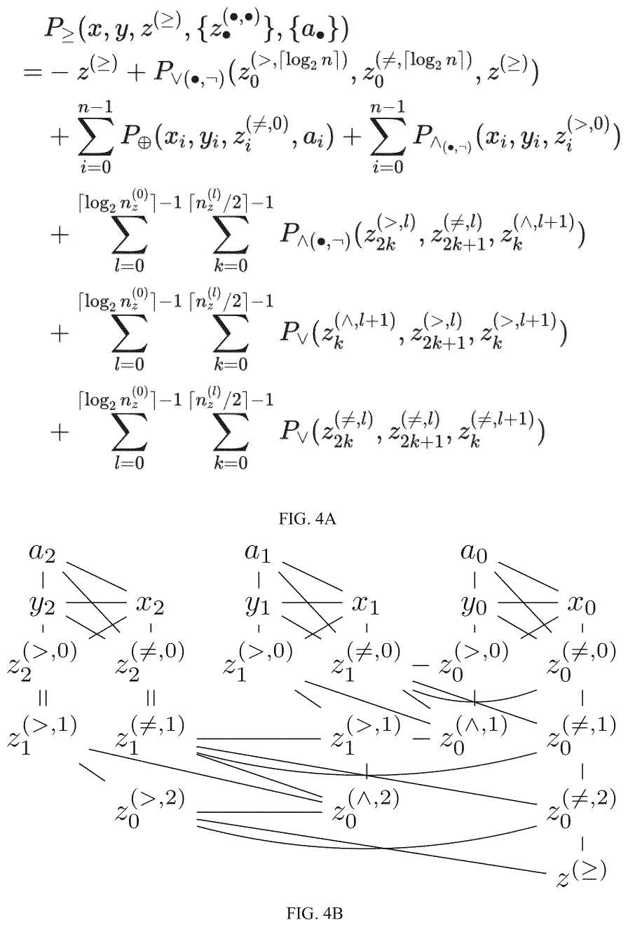

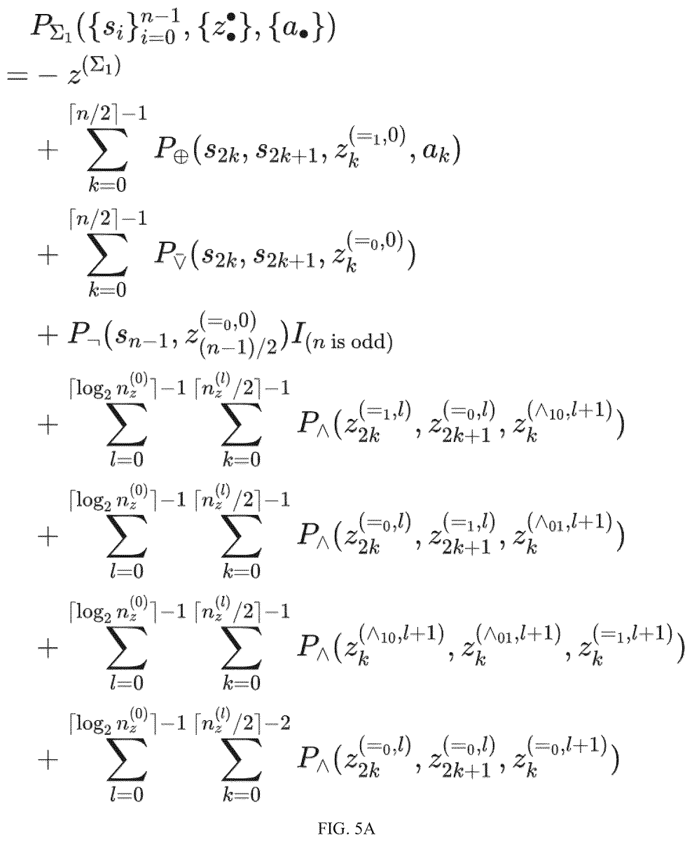

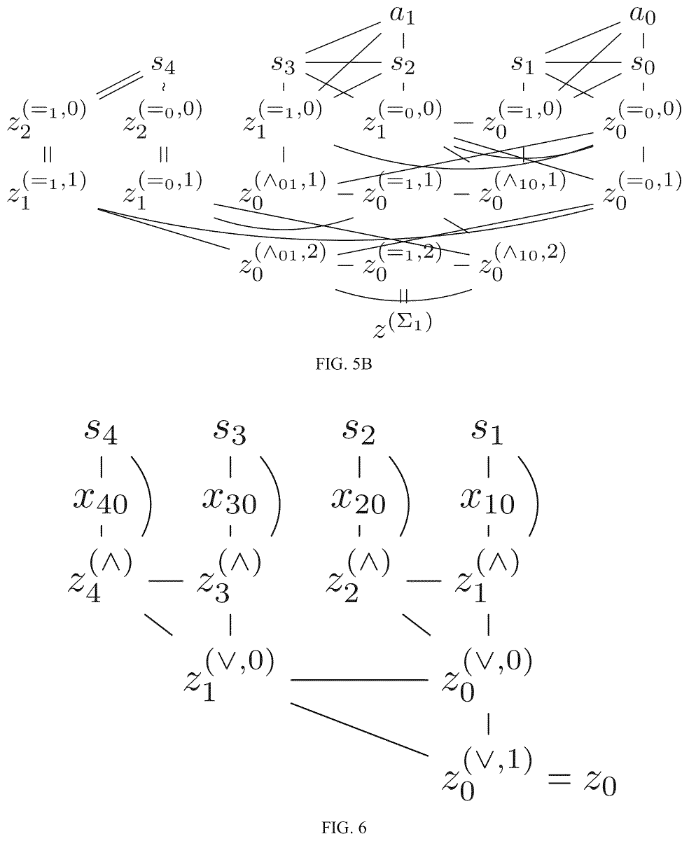

As shown in FIG. 2 to FIG. 6, the equality constraint is expanded into an equivalent quantum circuit for summating an XNOR-gate penalty term. The non-equality constraint is expanded into an equivalent quantum circuit for performing an AND operation on all bitwise XOR operation results. The inequality constraint is expanded bit by bit to make a high bit satisfy an inequality or make the high bit satisfy an equation and a low bit satisfy an inequality. The one-hot constraint is expressed as an equivalent quantum circuit for performing an OR operation on all AND operation results of adjacent bits. The selection constraint is expanded into the one-hot constraint and a bitwise selection, and the bitwise selection is expanded into an equivalent quantum circuit for performing an OR operation on all AND operation results of a to-be-selected variable and a one-hot variable. The extremum constraint is expanded to the corresponding inequality constraint and selection constraint before being further expanded according to the above steps. The summation constraint provides two implementations, which are selected based on a bit length of an augend.

In cascade construction of a carry chain based on Boolean logic gates, expansion is performed based on the lowest-bit of the sum, higher bits of the sum, and carry bits. The lowest-bit sum is expanded into an equivalent quantum circuit of an XOR gate. The lowest-bit carry is expanded into an equivalent quantum circuit of an AND gate. The high-bit sum is expanded into a three-input XOR gate for further expansion. For a carry bit generated by the summation of a higher sum bit, the carry bit is expanded into an equivalent quantum circuit of performing an OR operation on the AND operations of all the three pairs among the two corresponding input bits and the previous carry bit. In mixed construction based on the carry chain and a polynomial difference square, a carry chain quantum circuit is constructed as follows based on penalty terms of a half-adder and a full-adder. Half-adder: PHA (A, B, C, S)=[(A+B)−(2C+S)]2=A+2AB−4AC−2AS+B−4BC−2BS+4C+4CS+S; full adder: PFA (A, B, C, C′, S)=[(A+B+C) {2}−(2C′+S)]2=A+2AB+2AC−4AC′−2AS+B+2BC−4BC′−2BS+C−4CC′−2CS+4C′+4C'S+S. In this construction, a subsequent step is represented as a black box quantum circuit that does not participate in further optimization.
Step S6: A quantum circuit synthesis is constructed based on Ising perception and computer Boolean algebra in the high-level programming language, and functions including constant propagation, constant folding, NOT-gate fusion, chain-shaped reduction, tree-shaped reduction, computational strength reduction, sparse format export, and dense format export are provided.

The constant propagation is performed during initialization, the NOT-gate fusion, the chain-shaped reduction, the tree shaped reduction, the computational strength reduction, the sparse format export, and the dense format export to eliminate a bit with a known value as a constant and replace the bit with a constant until there is no bit with a known value as a constant.

The constant folding is performed after the constant propagation to simplify a constraint containing a constant until a remaining constraint does not contain a constant.

X single-input invereted AND 0=x; X single-input invereted AND 1-0; X single input-inverted OR 0=1; X single input-inverted OR 1=x; x AND 0=0; x AND 1=x; x OR 0=x; x OR 1=x; x NAND 0=1; x NAND 1=non-x; x NOR 0=non-x; x NOR 1=0; x XOR 0=x; x XOR 1=non-x. The NOT-gate fusion is performed when there is a NOT gate or an XNOR gate in a quantum circuit, to utilize an Ising characteristic to further eliminate qubit usage and qubit interactions, thereby reducing a dynamic range of the interaction.

When there is a NOT gate, the NOT gate is eliminated, and a gate that uses a result of the NOT gate is converted by using an original bit based on (AND <->single-input invereted AND <->NOR), (OR<->single input-inverted OR<->NAND), and (XOR <->XNOR). When there is an XNOR gate, the XNOR gate is replaced by the XOR gate, and a gate that uses a result of the XNOR gate is converted based on (AND <->single-input invereted AND <->NOR), (OR<->single input-inverted OR<->NAND), and (XOR <->XNOR).

The chain-shaped reduction converts an unstructured gate set into a chain topology quantum circuit through bitwise recurrence from high bit to low bit. The tree-shaped reduction converts the unstructured gate set into a tree topology quantum circuit through pairing and recursive binary merging greedy. The computational strength reduction decomposes multiplication with an integer constant into a shift-addition quantum circuit. The sparse format export exports the simplified quantum circuits in the above steps in a format of a coordinate index sparse matrix. A bit variable is sorted, a self-interaction is recorded into a diagonal term, and an interaction of a bit variable pair is merged into a corresponding subscript position. The dense format export exports the simplified quantum circuits in the above steps in a format of an upper triangular matrix. A bit variable is sorted, a self-interaction is recorded into a diagonal term, and an interaction of a bit variable pair is merged into a corresponding subscript position.

In the embodiments, a programming interface for a quantum Ising machine implementing quantum adiabatic computation and other general-purpose Ising machines is provided. The Ising machine programming interface includes:
an annealer-specific neutral input interface disposed in the high-level programming language and configured to provide a specific implementation for a real machine of a mainstream supplier to submit a quantum circuit to the real machine;
an annealer-specific neutral output interface disposed in the high-level programming language and configured to provide a specific implementation for the real machine of the mainstream supplier to obtain an operation process statistic and an operation result of the quantum circuit from the real machine; and
a numerical output and visualization system disposed in the high-level programming language and configured to provide a function of outputting and storing a numerical result and a function of visualizing an operation optimization process and result of the quantum circuit.

The function of outputting and storing the numerical result converts a result read back by the annealer-specific neutral output interface into a numerical matrix and stores the numerical matrix in a memory and/or a hard disk.

The function of visualizing the operation optimization process and result of the quantum circuit includes a column diagram of quantities of hits on different optimization target values and an evolution trajectory of a systematic Hamiltonian over time.

The method provided in the present disclosure is applied to efficiently solve constrained optimization problem instances represented by a large-scale NP-hard problem in electronic design automation, energy, finance, communication, and other domains on Ising machines represented by a quantum annealer. Steps are as follows:
Step 1: A Python language is used to import the quantum circuit synthesis system of the Boolean algebra of the Ising perceptual computer for solving the constrained optimization problem in the embodiments of the present disclosure.
Step 2: A required unconstrained optimization problem is constructed by using the domain-specific constrained optimization primitive expression system provided in the embodiments of the present disclosure.
Step 3: The domain knowledge decomposition, the Boolean expansion, and the quantum circuit synthesis based on Ising perception and computer Boolean algebra that are provided in the embodiments of the present disclosure are sequentially used to convert the problem instance into a universal format that can run on an advanced annealing computer led by the quantum Ising machine, is dominated by a QUBO, and describes the quantum circuit.
Step 4: The quantum circuit of the problem instance is submitted to a real machine of the annealing computer through the annealer-specific neutral input interface provided in the embodiments of the present disclosure, so as to solve the original constrained optimization problem.
Step 5: A solving process and/or a solving result are/is read back from the real machine of the annealing computer through the annealer-specific neutral output interface provided in the embodiments of the present disclosure.
Step 6: The solving process and/or the solving result are/is visually presented through the numerical output and visualization system provided in the embodiments of the present disclosure.

The embodiments of the present disclosure use the Boolean constraint primitive expression system described by the penalty term as a basic expression object, and carry out automatic, efficient, and reliable rearrangement and simplification through an algebra system of the Ising perceptual computer. In this way, combining a characteristic of the Ising machine, a scale of the optimization problem instance is reduced, thereby improving solving efficiency of the optimization problem instance on the Ising machine.

Compared with the mainstream methods dominated by polynomial expansion, the new method provided in the present disclosure greatly reduces expression complexity of an Ising problem obtained by encoding an NP-hard problem, increases an allowable scale of a solving problem of the existing quantum annealer, and improves the solving efficiency and annealing solution quality of the existing problem instance.

The theoretical analysis and the real machine experiment show that the method provided in the present disclosure improves optimal bit encoding efficiency, enhances locality of the interaction, and greatly reduces the dynamic range of the interaction. Therefore, (1) An integer encoding length is logarithmic to a dynamic range width of an integer variable. (2) An additional bit introduced by the constraint is logarithmic to the dynamic range width of the integer variable. (3) A quantity of interactions introduced by a single constraint on a single bit is a small constant independent of the integer encoding length. (4) A total quantity of interactions introduced by a single constraint is logarithmic to the dynamic range width of the integer variable. (5) A dynamic range of the interaction introduced by the constraint is a small constant independent of the integer encoding length. (6) A required bit quantity for deploying the large-scale constrained optimization problem instance on the real machine has been reduced to ½ to ⅓ of a bit quantity in the existing mainstream methods, which is equivalent to expanding an upper limit of a scale of a deployable constrained optimization problem on the real machine to 2 to 3 times.

1. A method for constructing a Boolean algebra system of an Ising perceptual computer, comprising the following steps:
step S1: constructing a domain-specific constrained optimization primitive expression system in a high-level programming language, and providing a parameterized abstract constrained optimization primitive for four domains of electronic design automation, finance, energy, and communication;
step S2: constructing a domain-independent constrained optimization primitive expression system in the high-level programming language, and providing parameterized abstract constrained optimization primitives comprising variable management, an equality constraint, a non-equality constraint, an inequality constraint, a one-hot constraint, a selection constraint, an extremum constraint, a summation constraint, and a linear constraint;
step S3: in the high-level programming language, for the four domains of electronic design automation, finance, energy, and communication, combined with domain-specific knowledge, constructing a domain knowledge decomposition from a first constrained optimization complex expressed by the domain-specific constrained optimization primitive expression system to a second constrained optimization complex expressed by the domain-independent constrained optimization primitive expression system, and expanding each domain-specific parameterized abstract constrained optimization primitive in the S1 into a set of each domain-independent parameterized abstract constrained optimization primitive in the S2;
step S4: constructing a Boolean constraint primitive expression system described by a penalty term quantum circuit in the high-level programming language, and providing a NOT-gate constraint, an AND-gate constraint, an OR-gate constraint, a constraint on derivation of a gate from single-input inversion, an XOR-gate constraint, and an XNOR-gate constraint;
step S5: in the high-level programming language, constructing a Boolean expansion from the second constrained optimization complex expressed by the domain-independent constrained optimization primitive expression system to a third constrained optimization complex expressed by the Boolean constraint primitive expression system described by the penalty term quantum circuit, and unstructurally expanding each domain-independent constrained optimization primitive in the S2 into an unstructured set of a Boolean constraint primitive described by each penalty term quantum circuit in the S4; and
step S6: constructing a quantum circuit synthesis based on Ising perception and computer Boolean algebra in the high-level programming language, and providing functions comprising constant propagation, constant folding, NOT-gate fusion, chain-shaped reduction, tree-shaped reduction, computational strength reduction, sparse format export, and dense format export.

2. The method for constructing the Boolean algebra system of the Ising perceptual computer according to claim 1, wherein the constraint on derivation of the gate from single-input inversion is obtained by expanding and simplifying a penalty term of a corresponding non-inverting gate through inverting variable substitution x→(1−x).

3. The method for constructing the Boolean algebra system of the Ising perceptual computer according to claim 1, wherein in the step S5, based on a domain, the equality constraint is expanded into an equivalent quantum circuit for summating an XNOR-gate penalty term, the non-equality constraint is expanded into an equivalent quantum circuit for performing an AND operation on all bitwise XOR operation results, the inequality constraint is expanded bit by bit to make a high bit satisfy an inequality or make the high bit satisfy an equation and a low bit satisfy an inequality, the one-hot constraint is expressed as an equivalent quantum circuit for performing an OR operation on all AND operation results of adjacent bits, the selection constraint is expanded into the one-hot constraint and a bitwise selection, the extremum constraint is expanded into the corresponding inequality constraint and selection constraint before being further expanded, and the summation constraint is expanded based on at least one expansion selected based on a bit length of an augend.

4. The method for constructing the Boolean algebra system of the Ising perceptual computer according to claim 3, wherein the bitwise selection is expanded into an equivalent quantum circuit for performing an OR operation on all AND operation results of a to-be-selected variable and a one-hot variable.

5. The method for constructing the Boolean algebra system of the Ising perceptual computer according to claim 1, wherein in the step 6, the constant propagation is performed during initialization, the NOT-gate fusion, the chain-shaped reduction, the tree shaped reduction, the computational strength reduction, the sparse format export, and the dense format export to eliminate a bit with a known value as a constant and replace the bit with a constant until there is no bit with a known value as a constant; and the constant folding is performed after the constant propagation to simplify a constraint containing a constant until a remaining constraint does not contain a constant.

6. The method for constructing the Boolean algebra system of the Ising perceptual computer according to claim 1, wherein in the step 6, the NOT-gate fusion is performed when there is a NOT gate or an XNOR gate in a quantum circuit, to utilize an Ising characteristic to further eliminate qubit usage and qubit interactions, thereby reducing a dynamic range of the interaction.

7. The method for constructing the Boolean algebra system of the Ising perceptual computer according to claim 6, wherein in the step 6,
when there is a NOT gate, the NOT gate is eliminated, and a gate that uses a result of the NOT gate is converted by using an original bit based on (AND <->single-input invereted AND <->NOR), (OR<->single input-inverted OR<->NAND), and (XOR <->XNOR); and
when there is an XNOR gate, the XNOR gate is replaced by an XOR gate, and a gate that uses a result of the XNOR gate is converted based on (AND <->single-input invereted AND <->NOR), (OR<->single input-inverted OR<->NAND), and (XOR <->XNOR).

8. The method for constructing the Boolean algebra system of the Ising perceptual computer according to claim 1, wherein in the step 6,
the chain-shaped reduction converts an unstructured gate set into a chain topology quantum circuit through bitwise recurrence from high bit to low bit;
the tree-shaped reduction converts the unstructured gate set into a tree topology quantum circuit through pairing and recursive binary merging greedy;
the computational strength reduction decomposes multiplication with an integer constant into a shift-addition quantum circuit;
the sparse format export exports, in a format of a coordinate index sparse matrix, the chain topology quantum circuit, the tree topology quantum circuit, and the shift-addition quantum circuit that are respectively obtained through the chain-shaped reduction, the tree-shaped reduction, and the computational strength reduction; and
the dense format export exports, in a format of an upper triangular matrix, the chain topology quantum circuit, the tree topology quantum circuit, and the shift-addition quantum circuit that are respectively obtained through the chain-shaped reduction, the tree-shaped reduction, and the computational strength reduction;
wherein the sparse format export and the dense format export sort a bit variable, record a self-interaction into a diagonal term, and merge an interaction of a bit variable pair into a corresponding subscript position.

9. An Ising machine programming interface, adopting the method for constructing the Boolean algebra system of the Ising perceptual computer according to claim 1, and comprising:
an annealer-specific neutral input interface disposed in the high-level programming language and configured to provide a first specific implementation for a real machine of a mainstream supplier to submit a quantum circuit to the real machine;
an annealer-specific neutral output interface disposed in the high-level programming language and configured to provide a second specific implementation for the real machine of the mainstream supplier to obtain an operation process statistic and an operation result of the quantum circuit from the real machine; and
a numerical output and visualization system disposed in the high-level programming language and configured to provide a function of outputting and storing a numerical result and a function of visualizing an operation optimization process and result of the quantum circuit.

10. The Ising machine programming interface according to claim 9, wherein the function of outputting and storing the numerical result converts a result read back from the annealer-specific neutral output interface into a numerical matrix and stores the numerical matrix in a memory and/or a hard disk; and the visualization function comprises a column diagram of quantities of hits on different optimization target values and an evolution trajectory of a systematic Hamiltonian over time.

11. The Ising machine programming interface according to claim 9, wherein in the method for constructing the Boolean algebra system of the Ising perceptual computer, the constraint on derivation of the gate from single-input inversion is obtained by expanding and simplifying a penalty term of a corresponding non-inverting gate through inverting variable substitution x→(1−x).

12. The Ising machine programming interface according to claim 9, wherein in the step S5 of the method for constructing the Boolean algebra system of the Ising perceptual computer, based on a domain, the equality constraint is expanded into an equivalent quantum circuit for summating an XNOR-gate penalty term, the non-equality constraint is expanded into an equivalent quantum circuit for performing an AND operation on all bitwise XOR operation results, the inequality constraint is expanded bit by bit to make a high bit satisfy an inequality or make the high bit satisfy an equation and a low bit satisfy an inequality, the one-hot constraint is expressed as an equivalent quantum circuit for performing an OR operation on all AND operation results of adjacent bits, the selection constraint is expanded into the one-hot constraint and a bitwise selection, the extremum constraint is expanded into the corresponding inequality constraint and selection constraint before being further expanded, and the summation constraint is expanded based on at least one expansion selected based on a bit length of an augend.

13. The Ising machine programming interface according to claim 12, wherein in the method for constructing the Boolean algebra system of the Ising perceptual computer, the bitwise selection is expanded into an equivalent quantum circuit for performing an OR operation on all AND operation results of a to-be-selected variable and a one-hot variable.

14. The Ising machine programming interface according to claim 9, wherein in the step 6 of the method for constructing the Boolean algebra system of the Ising perceptual computer, the constant propagation is performed during initialization, the NOT-gate fusion, the chain-shaped reduction, the tree shaped reduction, the computational strength reduction, the sparse format export, and the dense format export to eliminate a bit with a known value as a constant and replace the bit with a constant until there is no bit with a known value as a constant; and the constant folding is performed after the constant propagation to simplify a constraint containing a constant until a remaining constraint does not contain a constant.

15. The Ising machine programming interface according to claim 9, wherein in the step 6 of the method for constructing the Boolean algebra system of the Ising perceptual computer, the NOT-gate fusion is performed when there is a NOT gate or an XNOR gate in a quantum circuit, to utilize an Ising characteristic to further eliminate qubit usage and qubit interactions, thereby reducing a dynamic range of the interaction.

16. The Ising machine programming interface according to claim 15, wherein in the step 6 of the method for constructing the Boolean algebra system of the Ising perceptual computer,
when there is a NOT gate, the NOT gate is eliminated, and a gate that uses a result of the NOT gate is converted by using an original bit based on (AND <->single-input invereted AND <->NOR), (OR<->single input-inverted OR<->NAND), and (XOR <->XNOR); and
when there is an XNOR gate, the XNOR gate is replaced by an XOR gate, and a gate that uses a result of the XNOR gate is converted based on (AND <->single-input invereted AND <->NOR), (OR<->single input-inverted OR<->NAND), and (XOR <->XNOR).

17. The Ising machine programming interface according to claim 9, wherein in the step 6 of the method for constructing the Boolean algebra system of the Ising perceptual computer, the chain-shaped reduction converts an unstructured gate set into a chain topology quantum circuit through bitwise recurrence from high bit to low bit;
the tree-shaped reduction converts the unstructured gate set into a tree topology quantum circuit through pairing and recursive binary merging greedy;
the computational strength reduction decomposes multiplication with an integer constant into a shift-addition quantum circuit;
the sparse format export exports, in a format of a coordinate index sparse matrix, the chain topology quantum circuit, the tree topology quantum circuit, and the shift-addition quantum circuit that are respectively obtained through the chain-shaped reduction, the tree-shaped reduction, and the computational strength reduction; and
the dense format export exports, in a format of an upper triangular matrix, the chain topology quantum circuit, the tree topology quantum circuit, and the shift-addition quantum circuit that are respectively obtained through the chain-shaped reduction, the tree-shaped reduction, and the computational strength reduction;
wherein the sparse format export and the dense format export sort a bit variable, record a self-interaction into a diagonal term, and merge an interaction of a bit variable pair into a corresponding subscript position.
